(19) United States
(12) Patent Application Publication
(10) Pub. No.: US 2023/0046735 A1
(43) Pub. Date: Feb. 16, 2023

(54) COOLING SYSTEM

(71) Applicant: Dehumidified Air Solutions, Inc., Quebec (CA)

(72) Inventor: Ralph KITTLER, Quebec (CA)

(21) Appl. No.: 17/757,167

(22) PCT Filed: Dec. 10, 2019
(86) PCT No.: PCT/IB2019/060634

§ 371 Date: Jun. 10, 2022

(51) Int. Cl. F24F 3/14; F24F 1/0059

(52) U.S. Cl. CPC F24F 3/1405; F24F 1/0059; F24F 2110/10

(57) ABSTRACT

Embodiments relate generally to a cooling system. One embodiment relates to a cooling system that rejects heat to a fluid loop or water coil that is upstream of an evaporator. Embodiments find particular use in connection with humidity and temperature ontrol systems for indoor uses, non-limiting examples of which include indoor pool environments, indoor agriculture growing facilities, or other indoor facilities that require humidity and temperature control.

### FIELD OF THE DISCLOSURE

Embodiments of the present disclosure relate generally to a cooling system. One embodiment relates to a cooling system that rejects heat to a fluid loop or water coil that is upstream of an evaporator. Embodiments find particular use in connection with humidity and temperature control systems for indoor uses, non-limiting examples of which include indoor pool environments, indoor agriculture growing facilities, or other indoor facilities that require humidity and temperature control.

### BACKGROUND

In certain indoor agriculture, indoor pool room, or other indoor environments, it is necessary to manage the atmosphere of a closed, indoor room. Closed rooms do not have circulation of fresh air, so they are typically provided with a dehumidification system and/or air conditioning system that can maintain the desired humidity and temperature levels, as well as address other environmental needs.

In some instances, it is possible to use outdoor air to cool an indoor space in the winter. However, some agricultural grow rooms or indoor greenhouses should not receive outdoor air as it can negatively impact carbon dioxide levels. It is also possible that use of direct outdoor air can deliver undesirable pathogens or other bacteria to the grow room. The current approach in these situations is to operate compressors in the winter. However, this adds expense and energy usage to the system. Improvements are thus desirable.

### BRIEF SUMMARY

Embodiments of the present disclosure thus provide a way to cool an indoor space without using compressors in the winter, or when temperatures fall below about 60 or 65° F. The system uses cooling from circulating fluid to an outdoor dry cooler that cools the fluid by ambient air.

In some examples, there is provided a cooling system, comprising an outdoor air fluid cooler in fluid communication with a pre-cool coil, wherein the cooling system is installed upstream of a compressor system. The outdoor air fluid cooler may use outdoor cold air to provide chilled fluid without the use of a separate compressor. In one example, the pre-cool coil may be a water coil. It has been found beneficial to operate the system when temperatures are below about 60 or 65° F.

### BRIEF DESCRIPTION OF THE DRAWINGS

FIG. 1 shows a schematic illustrating use of the disclosed cooling system in connection with a multi-circuit compressor wall.

FIG. 2 shows a schematic illustrating the disclosed cooling system in connection with any appropriate compressor system.

### DETAILED DESCRIPTION

The cooling system disclosed may be used in connection with a compressor wall as described in co-pending Application Serial No. , titled “Compressor Wall,” which application shares a filing date with the present application, the entire contents of which are incorporated herein. However, the disclosed cooling system may be used with other types of dehumidification and cooling systems. Generally, this disclosure may be used with any type of system that reject heats to a hydronic loop.

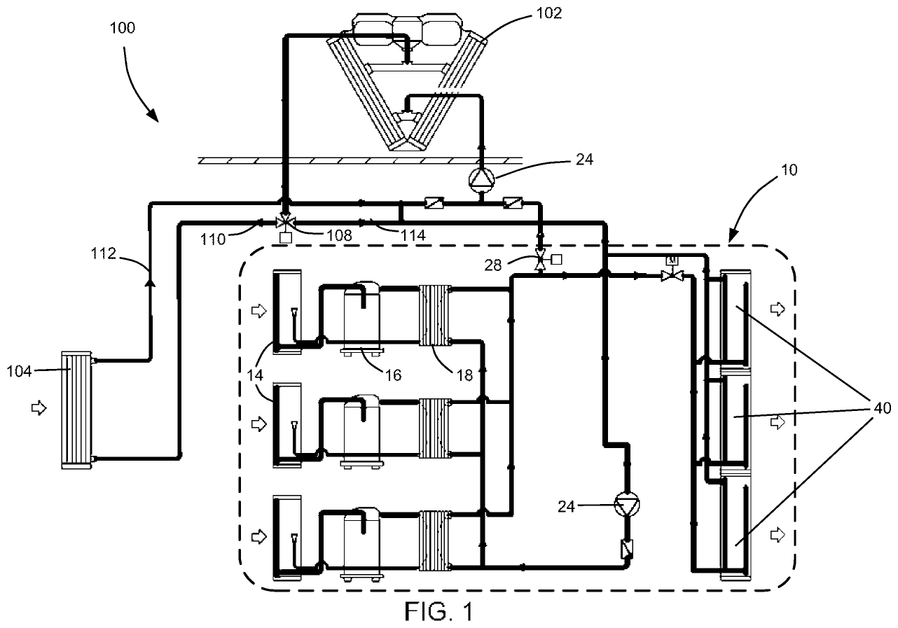

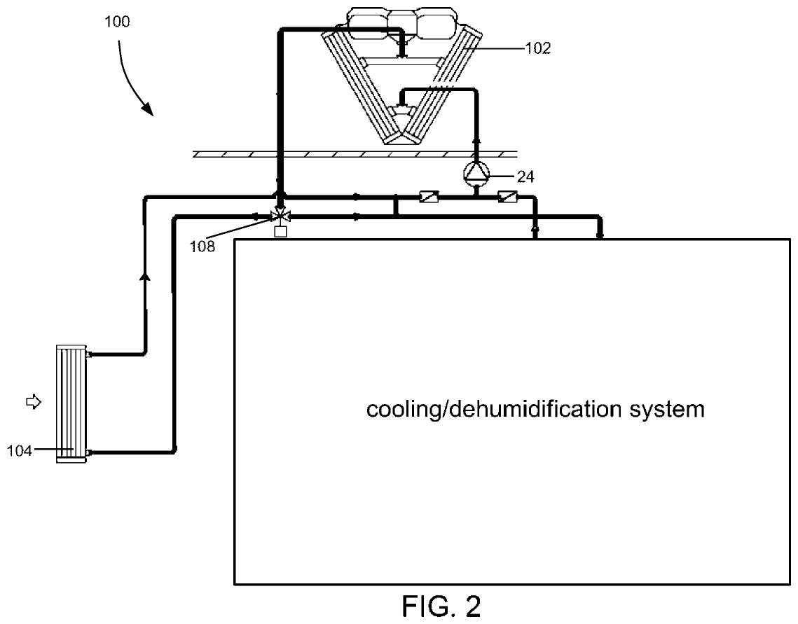

Embodiments of the present disclosure provide an economizer cooling system 100. FIG. 1 illustrates the use of this system 100 in use with a compressor wall system 10, disclosed in more detail in the above-referenced co-pending application. However, this example is provided for illustration purposes only and it should be understood that the disclosed cooling system 100 may be used in connection with any other type of appropriate or available compressor systems, shown schematically by FIG. 2.

Compressor systems are often used to cool indoor spaces, such as pool rooms and indoor grow rooms, even in colder months, in order to maintain the integrity of the air in the environment. These systems thus use fluid loops all year long. As is shown by the schematic of FIG. 1, the disclosed cooling system 100 provides a fluid cooled compressor system 10 paired to an outdoor dry cooler 102, also referred to as an outdoor air fluid cooler (OAFC) or a fluid cooler. The fluid cooler 102 is used for heat rejection in the summer. In the winter, the fluid cooler 102 is used to generate cold fluid. The OAFC 102 is generally positioned outside a building, and conduits deliver cooled fluid (that has been run through the OAFC 102 and cooled (naturally) by outdoor air) to the remainder of the system, which is positioned inside a building. Specifically, fluid flowing within the various conduits of the dehumidifier system 10 may be routed to the outdoor air fluid cooler 102 via a modulating valve 28. A fluid pump 24 may route fluid through the fluid cooler 102. The circulated fluid is cooled by the cold ambient air. It is generally envisioned that the disclosed cooling system 100 functions when temperatures are below at least 60 or 65 ° F. The cooled fluid may then be directed to a pre-cool heat exchanger coil 104 that is positioned upstream of an evaporator coil 14 (or one or more evaporator coils 14) of a dehumidifier system 10. This feature may also be referred to as an economizer coil 104 (or a water coil). This additional water coil 104 is installed upstream of the other evaporators 14 of the system 10. Air is chilled as it travels across pre-cool coil 104. Chilled water (from the OAFC 102) is pumped through the coil 104, taking advantage of the cooler air that is available in the winter without the use of a compressor. This results in a reduced energy consumption. This configuration is only activated when external temperatures are low enough that the water that flows to the pre- cool coil 104 can be cooled without the use of an additional compressor.

FIG. 1 also shows the use of a valve 108. This valve 108 may be referred to as a mixing valve or a diverter valve. In a specific embodiment, the valve is a mixing valve 108 that functions as a 3-way mixing valve. The valve 108 may receive fluid from the OAFC 102 and direct it to the pre-cool coil 104, as illustrated by conduit line/arrow 110. The valve 108 may also receive warmed return fluid from the pre-cool coil 104 and direct it back to the OAFC 102 along conduit line/arrow 112 to be re-cooled. The valve 108 may also direct cooled fluid from the OAFC 102, and rather than being sent to the pre-cool coil 104, the fluid can be sent along conduit line/arrow 114.

In one flow path, upon entering the indoor unit 10, the fluid passes through the valve 108. The valve 108 can then divert fluid to the brazed plate heat exchanger 18 when fluid it too warm to provide any free cooling, which is the case in summer. In cooler weather, however, the valve 108 can direct the fluid to the economizer cooling system 100 so that the OAFC 102 and the pre-cooling coil 104 can use outdoor air to cool the fluid before it is routed to the system 10. That same fluid is subsequently directed to the brazed plate heat exchanger 18 and eventually back to the outdoor air fluid cooler 102 via pumps 24.

The brazed plate heat exchanger 18 is one of two refrigerant condensers in the unit. Compressor heat that is not wanted can be rejected to the condenser 16, and the heat can be transferred to the fluid and carried away by the fluid to be rejected at the fluid cooler 102. When the compressor is operating for the purposes of dehumidification, some of the compressor hot gas can be redirected to the brazed plate heat exchanger 18 where the refrigerant is to be condensed. The heat is transferred to the hydronic loop, where it can then be circulated through the reheat coils 40 to temper the air. Gas leaving the reheat coils 40 leaves the system.

Referring more specifically to the air and fluid flow of FIG. 1, in the direction of air flow, the unit may have one or more filters followed by a precooling coil 104. This pre-cooling coil 104 may be a fluid coil that is on the dry cooler loop 110 (from the OAFC 102). This system 100 can be positioned before (or upstream) of one or more evaporator coil(s) 14 (on the compressor/DX circuit) and a modulating reheat coil 40. The outdoor located fluid cooler 102 has the dual task of rejecting heat in summer and creating cold fluid in cooler weather. To have a fluid cooler provide air conditioning or to be used together with the evaporator coil and then use a reheat coil for dehumidification is unique in a unit designed as a recirculated air, air handling unit.

This cooled fluid approach can reduce the refrigerant charge required as compared to traditional dehumidifiers. It allows the use of the cooled fluid for temperature control and humidity control and can be used in conjunction with compressors when outdoor conditions are cool enough to provide a low dew point and increase dehumidification capacity.

The disclosed fluid cooler system incorporates the fluid pump and accessories to circulate the fluid from the outdoor fluid cooler 102 to the indoor air handler system 10.

When the compressors in the dehumidifier system 10 are operating, the heat they generate is rejected into the fluid loop, also referred to as a hydronic loop. This heat can be used for reheating the indoor environment and/or it may be rejected outside the indoor environment. In one example, some growers using indoor grow rooms may alternate day and night cycles between their buildings in order to reduce operating costs. In this example, the heat generated from one building could be directed to and used at another building.

The disclosed system may be provided in a broad range of sizes in order to accommodate the various needs of different grow facilities. The addition of auxiliary heating may be an add-on to provide room heating for units located in cold climates.

The subject matter of certain embodiments of this disclosure is described with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

It should be understood that different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. Changes and modifications, additions and deletions may be made to the structures and methods recited above and shown in the drawings without departing from the scope or spirit of the invention disclosure and the following claims.

What is claimed is:

1. A cooling system, comprising:
an outdoor air fluid cooler in fluid communication with a pre-cool coil,
wherein the cooling system is installed upstream of a compressor system.

2. The cooling system of claim 1, wherein the outdoor air fluid cooler uses outdoor cold air to provide chilled fluid without the use of a separate compressor.

3. The cooling system of claim 1, wherein the pre-cool coil is a water coil.

4. The cooling system of claim 1, wherein the system is only operated when temperatures are below about 60 or 65° F.
